(19) United States
(12) Patent Application Publication
(10) Pub. No.: US 2004/0055415 A1
(43) Pub. Date: Mar. 25, 2004

(54) Eccentrically operated speed-variating device

(76) Inventor: Shih-Tzou Wen, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/251,951

(22) Filed: Sep. 23, 2002

(51) Int. Cl. F16H 48/12

(52) U.S. Cl. 74/650

(57) ABSTRACT

An eccentrically operated speed-variating device and, more particularly, a differential structure having a high power and high speed with sudden low speed (and zero speed) return function is constructed to include a main transmission shaft, a differential assembly mounted on the main transmission shaft and driven by a speed control arm to move a differential control wheel axially, and an eccentric driving wheel mounted around the main transmission shaft and controlled to change the eccentric radius thereof about the main transmission shaft upon axial movement of the differential control wheel.

### BACKGROUND OF THE INVENTION

1. 1. Field of the Invention

The present invention relates to speed-variating device and, more particularly, to a simple structure of eccentrically operated speed-variating device for use in, for example, a bicycle.

2. Description of the Related Art

Eccentrically operated speed-variating devices are known. U.S. Pat. No. 5,222,916, entitled “Eccentrically operated speed-variating means with broadened speed variation”, shows an exemplar. This structure of eccentrically operated speed-variating device is functional, however it is complicated and composed of a big number of parts, resulting in high manufacturing cost.

### SUMMARY OF THE INVENTION

The present invention has been accomplished under the circumstances in view. It is therefore the main object of the present invention to provide an eccentrically operated speed-variating device, which has a simple structure. It is another object of the present invention to provide an eccentrically operated speed-variating device, which is inexpensive to manufacture. To achieve these and other objects of the present invention, the eccentrically operated speed-variating device comprises a main transmission shaft, the main transmission shaft having a longitudinally extended axial center through hole; a sliding shaft axially slidably inserted into the longitudinally extended axial center through hole of the main transmission shaft, the sliding shaft having a first end terminating in an outer thread and extended out of one end of the main transmission shaft and a second end mounted with a linkage pivoted to an inside wall of the main transmission shaft; a differential assembly coupled to the sliding shaft, the differential assembly comprising a synchronous wheel fixedly fastened to the main transmission shaft for synchronous rotation, a differential control wheel arranged in parallel to the synchronous wheel, and a casing provided around the synchronous wheel and the differential control wheel, the differential control wheel having a diameter smaller than the synchronous wheel and a center screw hole threaded onto the outer thread of the sliding shaft; a speed control arm, the speed control arm having a fixed end pivoted to the casing and a free end mounted with two friction wheels of different diameters adapted for friction-contacting the periphery of the synchronous wheel and the periphery of the differential control wheel to force the sliding shaft to move axially in the main transmission shaft when the speed reducing arm turned in one direction relative to the casing; and an eccentric driving wheel mounted around the main transmission shaft and controlled by the linkage of the sliding shaft to change the eccentric radius thereof about the main transmission shaft.

### BRIEF DESCRIPTION OF THE DRAWINGS

FIG. 1 is sectional assembly view of an eccentrically operated speed-variating device according to the present invention.

FIG. 2 is similar to FIG. 1 but showing the sliding shaft moved in the main transmission shaft, the eccentric radius of the driving wheel about the main transmission shaft changed.

FIG. 3 is an exploded view of a part of the eccentrically operated speed-variating device according to the present invention.

FIG. 4 is a schematic drawing showing the friction wheels forced into friction-contact with the synchronous wheel and differential control wheel of the differential assembly according to the present invention.

FIG. 5 is a sectional view of a part of the present invention, showing the relative positioning of the main transmission shaft, the sliding shaft, the speed control arm, and the differential assembly according to the present invention.

FIG. 6 is an exploded view of a part of the present invention, showing the relative positioning of the sliding blocks between the driving wheel and one clutch control wheel.

FIG. 7 is a front view of a part of the present invention showing the sliding blocks positioned in the driving wheel.

FIG. 8 is a sectional view of a part of the present invention, showing the sliding blocks positioned in the endless sliding groove of one clutch control wheel.

FIG. 9 is a schematic drawing showing the speed control arm provided with two sets of friction wheels.

### DETAILED DESCRIPTION OF THE PREFERRED EMBODIMENT

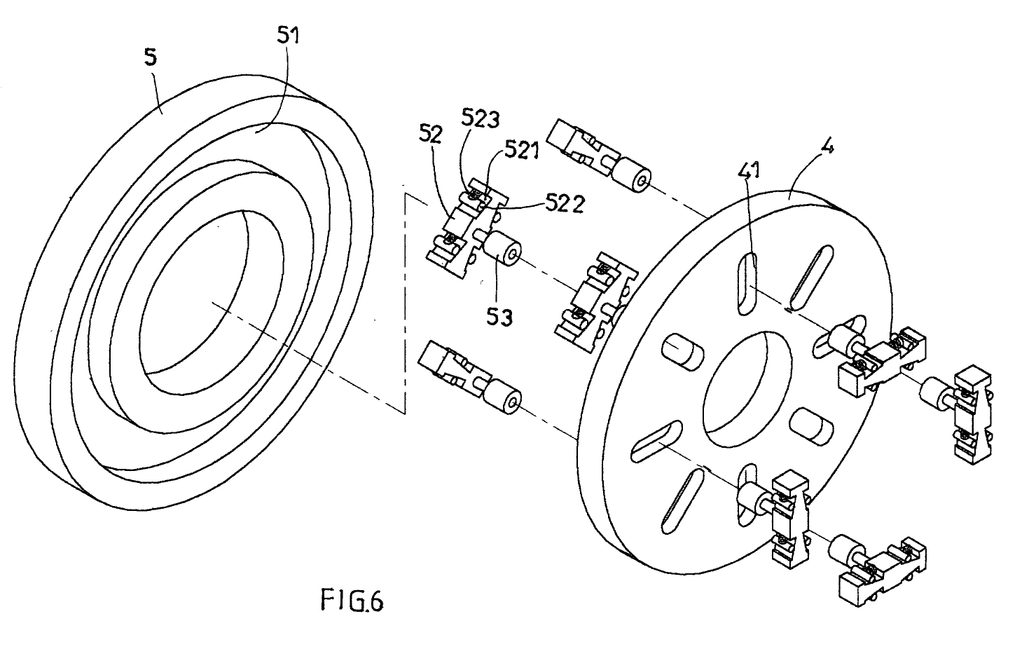

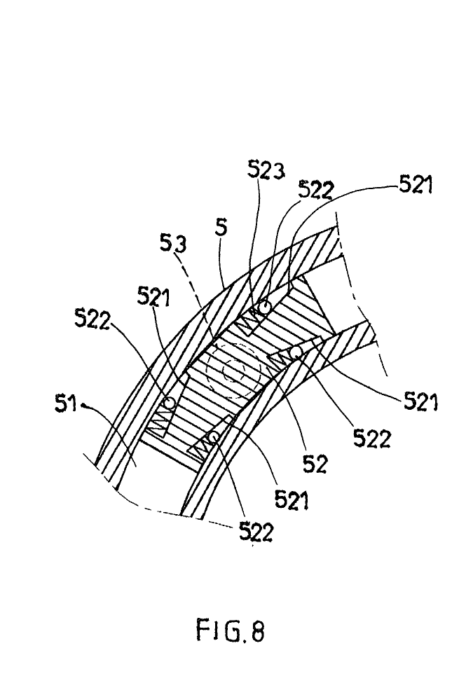

Referring to FIGS. from 1 through 5, an eccentrically operated speed-variating device in accordance with the present invention is shown comprising a main transmission shaft 2. A sliding shaft 22 is axially slidably inserted into the longitudinally extended axial center through hole 21 of the main transmission shaft 2. The sliding shaft 22 has an outer thread 23 disposed at one end and connected to a differential assembly 1. The differential assembly 1 comprises a synchronous wheel 12 and a differential control wheel 11. The synchronous wheel 12 is fixedly fastened to the main transmission shaft 2 for synchronous rotation. The diameter of the synchronous wheel 12 is greater than the differential control wheel 11. The outer thread 23 of the sliding shaft 22 is inserted through the center hole of the synchronous wheel 12 and supported on an axle bearing 13 at the synchronous wheel 12 and threaded into the center screw hole 111 of the differential control wheel 11. The other end of the sliding shaft 22 is mounted with a first link 24 and a second link 25. The first link 24 has one end pivoted to the sliding shaft 22, and the other end pivoted to one end of the second link 25. A pivot 252 pivots the other end of the second link 25 to a part of the main transmission shaft 2 inside the longitudinally extended axial center through hole 21. A motor 8 is provided and controlled to rotate the main transmission shaft 2. The sliding shaft 22 is synchronously rotated with the main transmission shaft 2 during operation of the motor 8. The main transmission shaft 2 has two transverse sliding grooves 211 arranged in the periphery in parallel. A lifting block 31 is coupled to the main transmission shaft 2, and vertically movable along the transverse grooves 211. The lifting block 31 has an opening 31 fitting the transverse grooves 211. An axle bearing 32 is supported on the lifting block 31 around the main transmission shaft 2. A driving wheel 4 is supported on the axle bearing 32 around the main transmission shaft 2, having a plurality of equiangularly spaced radial slots 41. Two clutch control wheels 5 are provided at two sides of the driving wheel 4 around the main transmission shaft 2, and respectively fastened to a power output wheel hub 6 and a transmission sleeve 7. The clutch control wheels 5 each have an endless sliding groove 51 disposed at an inner side around the center. The transmission sleeve 7 has one end fixedly mounted with a gear wheel 71 for receiving an external driving force. A plurality of sliding blocks 52 are alternatively mounted in the radial slots 41 of the driving wheel 4 at two sides and respectively coupled to the endless sliding grooves 51 of the clutch control wheels 5. Each sliding block 52 comprises a roller 53 provided at one side thereof and coupled to one radial slot 41 of the driving wheel 4, a plurality of springs 523 respectively mounted in a respective beveled receiving space at the other side thereof, and a plurality of needle rollers 522 respectively supported on the springs 523 and facing the endless sliding groove 51 of one clutch control wheel 5. (see FIGS. 6˜8).

Two push pins 253 are radially mounted in the main transmission shaft 2 and vertically aligned at two sides, each having an outer end respectively disposed in contact with the inside wall of the lifting block 3 and the inside wall of the axle bearing 32 and an inner end respectively disposed in contact with an endpiece 251 of the second link 25.

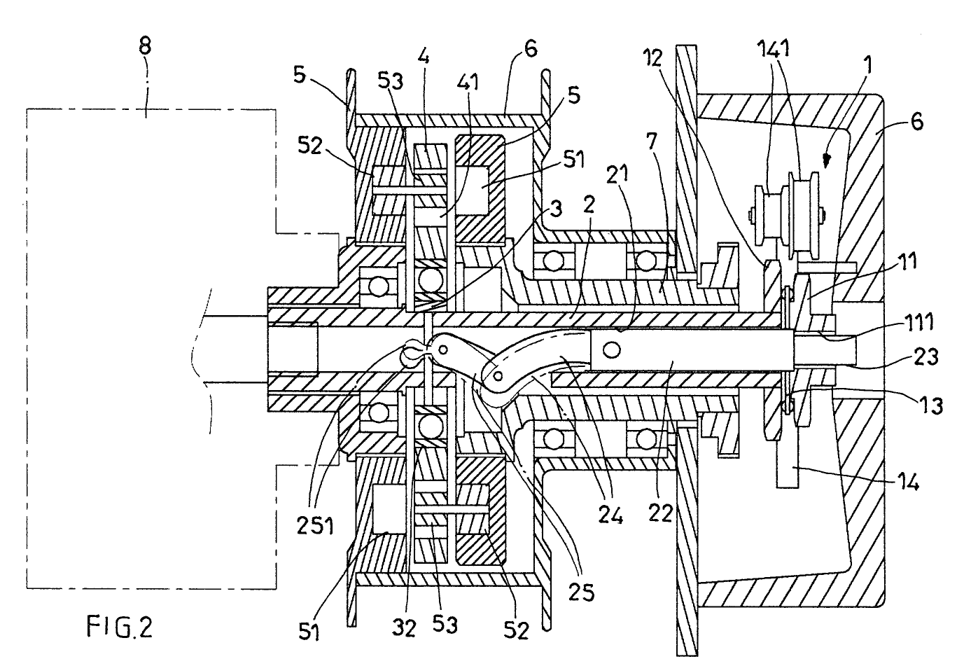

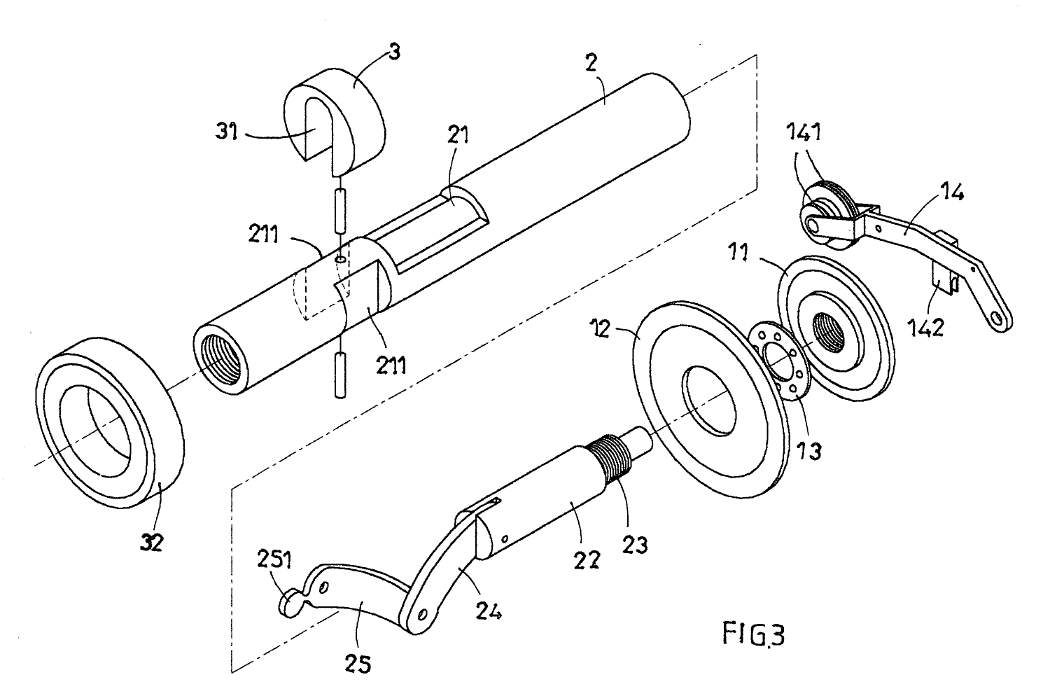

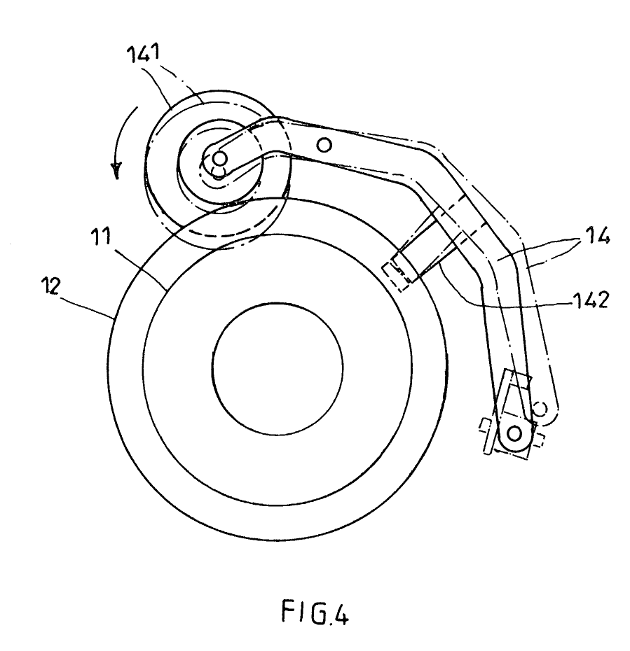

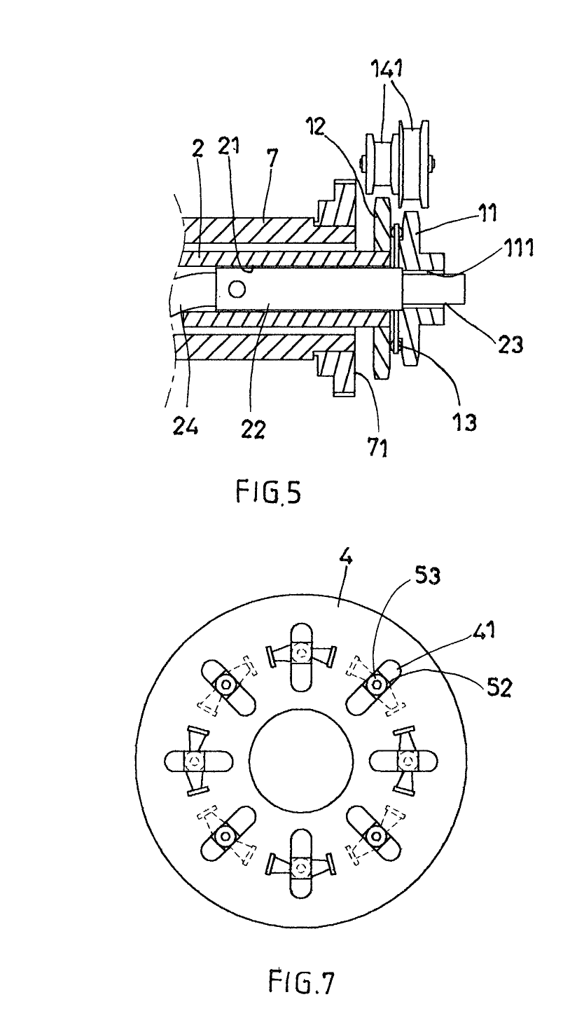

A casing 61 is provided around the differential assembly 1. A speed control arm 14 is provided having a fixed end pivoted to the inside wall of the casing 61 and a free end mounted with at least one set of differential transmission wheels, for example, two friction wheels 141 of different diameters. By means of pulling the speed reducing control cable (not shown), the speed control arm 14 is lowered to force the friction wheels 141 into friction-contact with the periphery of the synchronous wheel 12 and the periphery of the differential control wheel 11. Therefore, when the motor 8 started to rotate the main transmission shaft 2, the friction wheels 141 are driven by the synchronous wheel 12 to rotate the differential control wheel 11, thereby causing the differential control wheel 11 to move the sliding shaft 22 axially in the main transmission shaft 2. At this time, the endpiece 251 of the second link 25 is forced against the push pins 253, thereby causing the lifting block 3 and the driving wheel 4 to be moved vertically upwards (or downwards). When the lifting block 3 and the driving wheel 4 moved upwards (or downwards), the sliding blocks 52 are moved relative to the radial slots 41 of the driving wheel 4 to change the eccentric radius of the driving wheel 4 about the main transmission shaft 2 (see FIG. 2).

Further, a fixed friction device 142 is provided at a middle part of the speed control arm 14. When pulling the speed control arm 14 in the reversed direction, the fixed friction device 142 is forced into friction-contact with the periphery of the differential control wheel 11, achieving a broader speed variation ratio between the differential control wheel 11 and the main transmission shaft 2. At this time, the sliding shaft 22 is moved axially toward the right to return the links 24 and 25 to their former positions, and therefore the driving wheel 4 is moved with the axle bearing 32 and the lifting block 3 relative to the main transmission shaft 2 to the zero the eccentric radius of the driving wheel 4 about the main transmission shaft 2.

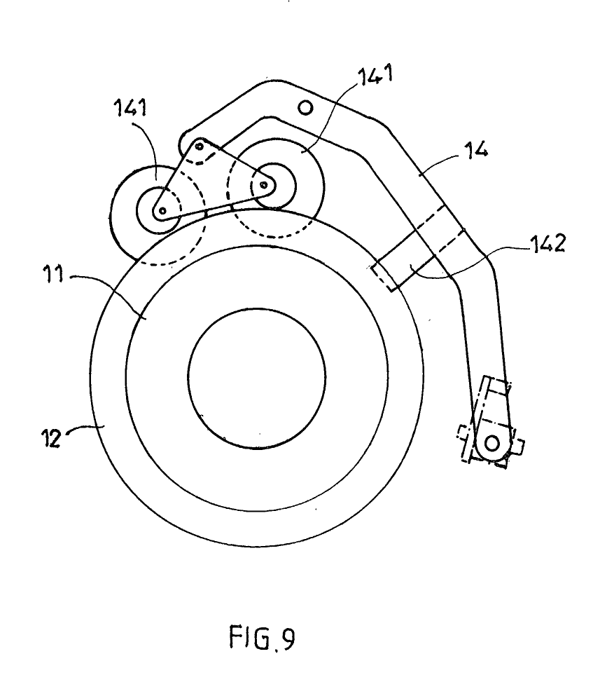

FIG. 9 is a schematic drawing of an alternate form of the present invention. According to this alternate form, the speed control arm 14 is mounted with two sets of differential transmission wheels (friction wheels) 141 adapted to peripherally engage the wheels 11 and 12.

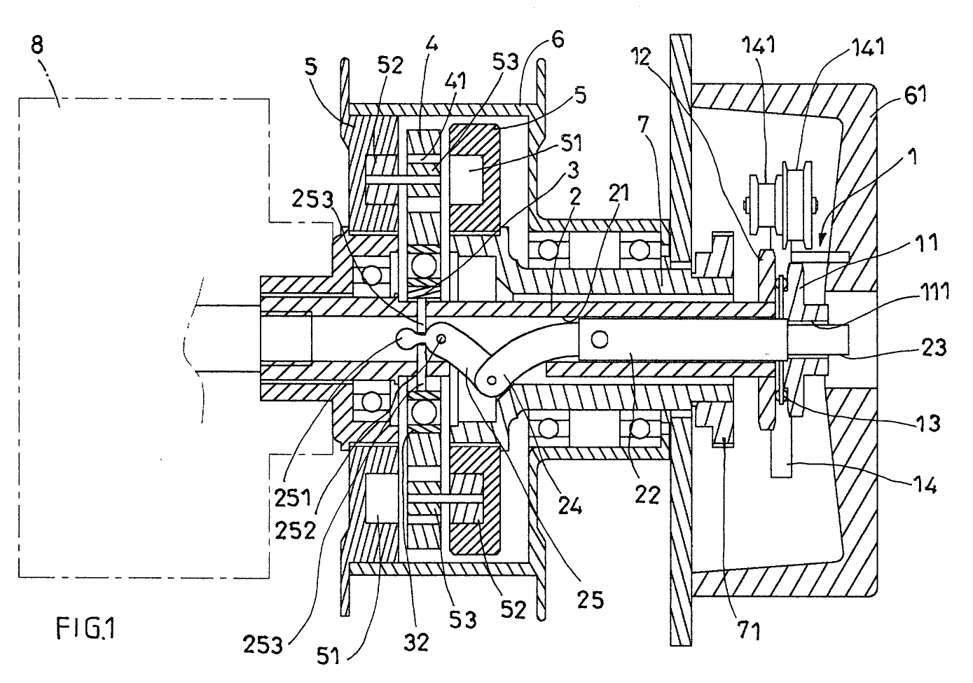

A prototype of eccentrically operated speed-variating device has been constructed with the features of FIGS. 1˜9. The eccentrically operated speed-variating device functions smoothly to provide all of the features discussed earlier.

It is to be understood that the drawings are designed for purposes of illustration only, and are not intended for use as a definition of the limits and scope of the invention disclosed.

What the invention claimed is:

1. An eccentrically operated speed-variating device comprising:
a main transmission shaft, said main transmission shaft having one end externally threaded;
a differential assembly coupled to said sliding shaft, said differential assembly comprising a synchronous wheel fixedly fastened to said main transmission shaft for synchronous rotation, a differential control wheel threaded onto the externally threaded end of said main transmission shaft for synchronous rotation with said synchronous wheel, and a casing provided around said synchronous wheel and said differential control wheel, said differential control wheel having a diameter smaller than said synchronous wheel and a center screw hole threaded onto the externally threaded end of said main transmission shaft;
a speed reducing control arm, said speed reducing control arm having a fixed end pivoted to said casing and a free end mounted with at least one set of differential transmission wheels each set of said at least one set of differential transmission wheels comprised of two differential transmission wheels of different diameters adapted for engaging the periphery of said synchronous wheel and the periphery of said differential control wheel to cause said differential control wheel to rotate at a speed higher than said main transmission shaft and then to move axially on said main transmission shaft, said speed control arm further comprising a friction device on the middle, which is forced into friction-contact with the periphery of said differential control wheel to cause said differential control wheel to rotate at a speed lower than said main transmission shaft when said speed control arm turned relative to said casing in the reversed direction to move said differential transmission wheels away from said synchronous wheel and said differential control wheel, thereby achieving a two-way link control;
an eccentric driving wheel mounted around said main transmission shaft and controlled to change the eccentric radius thereof about said main transmission shaft upon axial movement of said differential control wheel; and
a link coupled between said eccentric driving wheel and said differential control wheel.

2. An eccentrically operated speed-variating device comprising:
a main transmission shaft, said main transmission shaft having a longitudinally extended axial center through hole;
a sliding shaft axially slidably inserted into the longitudinally extended axial center through hole of said main transmission shaft, said sliding shaft having a first end terminating in an outer thread and extended out of one end of said main transmission shaft and a second end mounted with a linkage pivoted to an inside wall of said main transmission shaft;
a differential assembly coupled to said sliding shaft, said differential assembly comprising a synchronous wheel fixedly fastened to said main transmission shaft for synchronous rotation, a differential control wheel arranged in parallel to said synchronous wheel, and a casing provided around said synchronous wheel and said differential control wheel, said differential control wheel having a diameter smaller than said synchronous wheel and a center screw hole threaded onto the outer thread of said sliding shaft;
a speed reducing control arm, said speed reducing control arm having a fixed end pivoted to said casing and a free end mounted with two differential transmission wheels of different diameters adapted for engaging the periphery of said synchronous wheel and the periphery of said differential control wheel to force said sliding shaft to move axially in said main transmission shaft when said speed reducing arm turned in one direction relative to said casing, said speed control arm further comprising a friction device on the middle, which is forced into friction-contact with the periphery of said differential control wheel when said speed control arm turned relative to said casing in the reversed direction to move said differential transmission wheels away from said synchronous wheel and said differential control wheel; and
an eccentric driving wheel mounted around said main transmission shaft and controlled by said linkage of said sliding shaft to change the eccentric radius thereof about said main transmission shaft.

3. The eccentrically operated speed-variating device as claimed in claim 2, further comprising a lifting block coupled to said main transmission shaft, an axle bearing supported on said lifting block around said main transmission shaft, two push pins radially mounted in said main transmission shaft and respectively disposed in contact between an endpiece of said linkage at two sides for moving said lifting block and said axle bearing relative to said main transmission shaft to change the eccentric radius of said eccentric driving wheel about said main transmission shaft subject to the position of said sliding shaft in said main transmission shaft.

4. An eccentrically operated speed-variating device comprising:
a main transmission shaft coupled to a motor, said main transmission shaft having a longitudinally extended axial center through hole, and two transverse sliding grooves arranged in parallel in the periphery thereof at two sides;
a sliding shaft axially slidably inserted into the longitudinally extended axial center through hole of said main transmission shaft, said sliding shaft having a first end terminating in an outer thread and extended out of one end of said main transmission shaft and a second end;
a first link, said first link having a first end pivoted to the second end of said sliding shaft and a second end;
a second link, said second link having a first end pivoted to the second end of said first link, a second end pivoted to an inside wall of said main transmission shaft, and an endpiece extended from the second end thereof and suspended inside said main transmission shaft;
a differential assembly coupled to said sliding shaft, said differential assembly comprising a synchronous wheel fixedly fastened to said main transmission shaft for synchronous rotation, a differential control wheel arranged in parallel to said synchronous wheel, said differential control wheel having a diameter smaller than said synchronous wheel and a center screw hole threaded onto the outer thread of said sliding shaft, a casing provided around said synchronous wheel and said differential control wheel, and a speed control arm, said speed control arm having a fixed end pivoted to said casing and a free end mounted with two differential transmission wheels of different diameters adapted for friction-contacting the periphery of said synchronous wheel and the periphery of said differential control wheel to force said sliding shaft to move axially in said main transmission shaft when said speed control arm turned in one direction relative to said casing;
a lifting block coupled to the transverse sliding grooves of said main transmission shaft and vertically movable along said transverse sliding grooves;
an axle bearing supported on said lifting block around said main transmission shaft;
an eccentric driving wheel supported on said axle bearing around said main transmission shaft and controlled by the endpiece of said second link to change the eccentric radius thereof about said main transmission shaft;
two push pins radially mounted in said main transmission shaft and respectively disposed in contact with the endpiece of said second link at two sides for moving said lifting block and said axle bearing relative to said main transmission shaft to change the eccentric radius of said eccentric driving wheel about said main transmission shaft subject to the position of said sliding shaft in said main transmission shaft;
an output wheel hub for output of driving force from said eccentric driving wheel;
a transmission sleeve mounted on one end of said output wheel hub by an axle bearing, said transmission sleeve having a gear wheel fixedly provided at an outer end thereof and adapted for receiving an external driving force; and
a clutch device, said clutch device comprising two clutch control wheels disposed at two sides of said eccentric driving wheel around said main transmission shaft and respectively fastened to said power output wheel hub and said transmission sleeve, said clutch control wheels each having an endless sliding groove disposed at an inner side around the center, and a plurality of sliding blocks alternatively mounted in equiangularly spaced radial slots in said eccentric driving wheel at two sides and respectively coupled to the endless sliding grooves of said clutch control wheels, said sliding block each comprising a roller provided at one side thereof and coupled to one radial slot of said eccentric driving wheel, a plurality of springs respectively mounted in a respective beveled receiving space at an opposite side thereof, and a plurality of needle rollers respectively supported on said springs and facing the endless sliding groove of one of said clutch control wheels.
